(19) United States
(12) Patent Application Publication
(10) Pub. No.: US 2008/0295339 A1
(43) Pub. Date: Dec. 4, 2008

(54) Hand-operated multi-function cutting tool

(75) Inventors: Daniel J. Lipscomb, Prairie du Sac, WI (US); Jason Crowell, Madison, WI (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/809,986

(22) Filed: Jun. 4, 2007

(51) Int. Cl. B26B 13/00

(52) U.S. Cl. 30/194

(57) ABSTRACT

A hand-operated multi-function cutting tool includes a first elongated member having a handle portion, a midportion, and a blade portion, the blade portion having a first cutting edge along a top of the blade portion and a second cutting edge along a bottom of the blade portion. A second elongated member includes a handle portion, a midportion, and a blade portion, the blade portion having a first cutting edge along a top of the blade portion and a second cutting edge along a bottom of the blade portion. A pivot joint unites the midportions for scissor movement of the handle portions and the blade portions about the pivot joint.

### FIELD

The present invention relates to a hand-operated, multi-function cutting tool. The present invention relates more particularly to a hand-operated, multi-function cutting tool, such as a pair of snips, having internal cutting edge(s) for cutting objects in a shearing manner and external cutting edge(s) for cutting objects in a non-shearing manner.

### BACKGROUND

It is generally known to provide a hand-operated tool such as a snips, shears, scissors or the like having a pair of pivoting members with sharpened internal edges that slide past one another to cut an object placed between the sharpened edges. However, such known tools are typically not also designed for cutting in a knife or saw like manner using a sharpened exterior edge.

It is also generally known to provide a hand-operated tool such as a knife having a blade portion with one or two sharpened edges that operated to cut objects by sliding or pressing the sharpened edge against an object. However, such known tools are typically not also designed for cutting objects in a scissor-like manner. It is also generally known to provide “multi-tool devices” that include a knife and a scissors, but are usually combined with other tools that require a user to separately open the knife and/or the scissors from a folded/stowed configuration to access/use the knife and scissors. Thus, there is a need for a pivoting cutting tool that eliminates the need to carry a separate knife, and/or having to separately open/access a knife from other tools in a multi-tool device.

Accordingly, it would be desirable to provide a hand-operated, multi-function cutting tool, such as a pair of snips, having a pair of pivotally connected blades with internal sharpened edges for cutting objects in a scissor like manner. It would also be desirable to provide a hand-operated, multi-function cutting tool having a pair of pivotally connected blades with external sharpened edges for cutting objects in a knife or saw-like manner. It would also be desirable to provide a hand-operated, multi-function cutting tool with an external sharpened smooth/fine edge and an external sharpened serrated edge. It would also be desirable to provide a hand-operated, multi-function cutting tool having a jaw with a flat surface arranged to engage an opposing blade in an anvil-like manner, with the jaw including an external sharpened edge. It would be further desirable to provide a hand-operated, multi-function cutting tool that includes a lock device for maintaining the blades in a closed position, such as when use of the tool in a knife or saw like manner is desired.

Accordingly, it would be desirable to provide a hand-operated, multi-function cutting tool having any one or more of these or other desirable features.

### SUMMARY

According to one embodiment, a hand-operated multi-function cutting tool includes a first elongated member having a handle portion, a midportion, and a blade portion, the blade portion having a first cutting edge along a top of the blade portion and a second cutting edge along a bottom of the blade portion. A second elongated member is provided having a handle portion, a midportion, and a blade portion, the blade portion having a first cutting edge along a top of the blade portion and a second cutting edge along a bottom of the blade portion. A pivot unites the midportions for scissor movement of the handle portions and the blade portions about the pivot.

According to another embodiment, a hand-operated multi-function cutting tool includes first and second opposed elongated members. Each member has a blade segment at a front end portion thereof, a handle segment at a rear end portion thereof, and a midportion where the members cross over each other. Each blade segment includes an internal cutting edge and at least one of the blades includes an external cutting edge. A pivot joint unites the midportions for scissor movement of the handle segments and blade segments about the pivot joint between an open position and a closed position, so that the internal cutting edges are configured to cut an object in a shearing manner and the external cutting edge is configured to cut an object in a non-shearing manner.

According to a further embodiment, a hand-operated multi-function cutting tool includes first and second opposed elongated members. Each member has a jaw at a front end portion thereof, a handle segment at a rear end portion thereof, and a midportion where the members cross over each other. A pivot joint unites the midportions for scissor movement of the handle segments and jaws about the pivot joint between an open position and a closed position. One jaw includes an internal anvil surface and the other jaw includes an internal cutting surface that engages the anvil surface when the handle segments are in the closed position. At least one of the jaws having an external cutting surface.

### BRIEF DESCRIPTION OF THE DRAWINGS

FIG. 1 is a schematic image of a perspective view of a hand-operated, multi-function cutting tool according to an exemplary embodiment.

FIG. 2 is a schematic image of a side elevation view of a hand-operated, multi-function cutting tool according to the embodiment of FIG. 1.

FIG. 3 is a schematic image of an exploded perspective view of a hand-operated, multi-function cutting tool according the embodiment of FIG. 1.

FIG. 4 is a schematic image of a perspective view of a hand-operated, multi-function cutting tool according to an another embodiment.

### DETAILED DESCRIPTION

Referring to the FIGURES, a hand-operated, multi-function cutting tool, shown for example as a pair of snips, is shown according to an exemplary embodiment. The snips are shown to include two elongated, opposed members - each having a handle end, and a blade end, and a midportion between the handle and blade ends. The handle ends are shown to include ergonomically contoured handles, that are movable between an open position and a closed position for actuating the blades in a scissor or shearing operation to cut objects placed between the blades. The midportions are shown to include a pivot connection for operating the blades in a scissor like manner, and also to include structure for receiving a locking device. The locking device is actuatable between a “locked” position to maintain the blades in the closed position and a “use” position to permit the blades to be opened (e.g. spring-biased or “sprung-open”). The blade ends are shown to include internal (e.g. inward facing) surfaces having a sharpened edge in the form of a blade for cutting objects in a shearing manner when the blades/handles are closed, and external (e.g. outward facing) surfaces having a sharpened edge in the form of a blade (shown for example as one serrated edge and one smooth/fine edge). The blades are positioned so that in the closed position, the external sharpened edge of one blade extends outwardly beyond the internal sharpened edge of the opposite blade.

Accordingly, the snips can be used in a scissor-like manner to cut objects between the blades with the internal edges, and to cut objects in a non-scissor-like manner (e.g. in a knife-like or saw-like manner) with the external edges (with the blades in the open or closed position). It should be noted that the external edge of one or both blades may be sharpened and can have any of a wide variety of cutting surface shapes (e.g. smooth, serrated, saw-tooth, etc.). In addition, the lock device may operate in any suitable manner (e.g. slide, push-pull, lever, etc.). Further, the blade portion of one of the elongated members may be provided having a generally flat (e.g. planar, etc.) surface arranged to bear against the sharpened internal edge of the other blade portion (e.g. in an anvil-like manner). Accordingly, the embodiments illustrated in the FIGURES are shown by way of example, and any of a wide variety of blade, handle, and lock styles or shapes, and combinations thereof, will be readily apparent to a person of ordinary skill in the art after reviewing this disclosure. All such variations are intended to be within the scope of the invention.

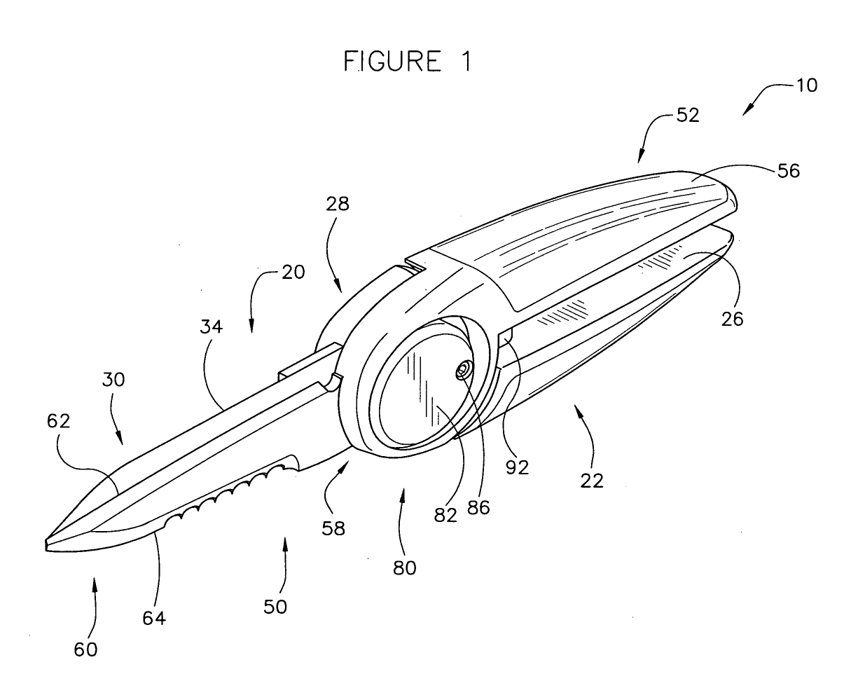

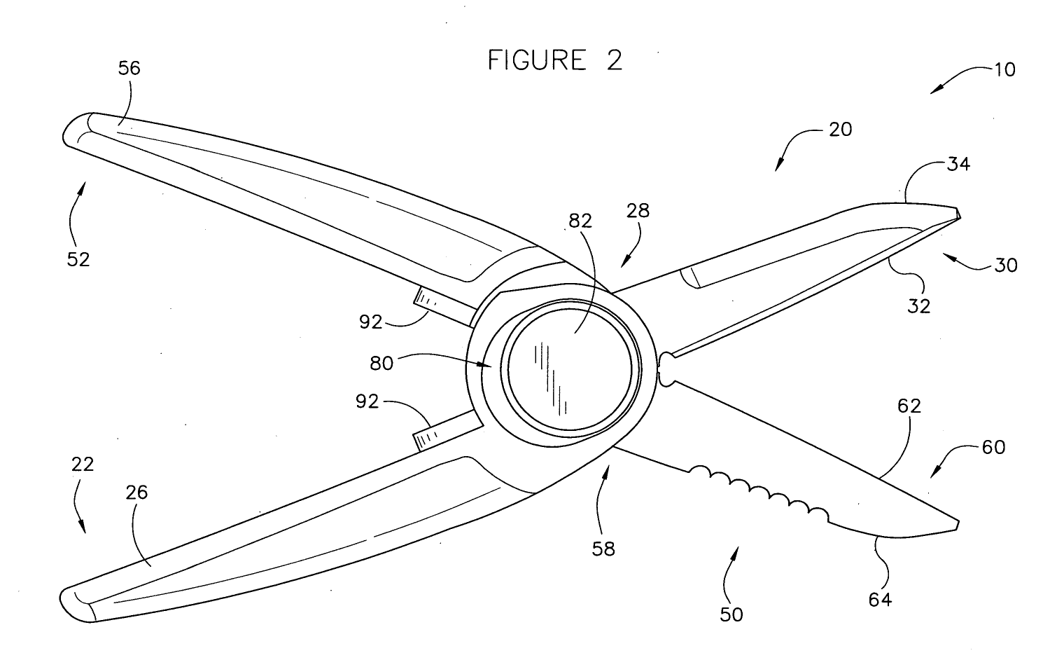

Referring to FIGS. 1-3, a multi-function hand-operated cutting tool, such as a snips 10, is shown according to one embodiment. Snips 10 include opposed elongated members 20, 50. Elongated member 20 includes a handle end 22 having a tang 24 for receiving a handle 26, and a midportion 28, and a blade end 30 (e.g. jaw, etc.) having an internal edge 32 and an external edge 34. Similarly, elongated member 50 includes a handle end 52 having a tang 54 for receiving a handle 56, and a midportion 58, and a blade end 60 (e.g. jaw, etc.) having an internal edge 62 and an external edge 64. The midportions 28, 58 each include an aperture 66 defining a pivot point for operation of the elongated members in a scissor-like manner.

According to the illustrated embodiment, the internal edges 32, 62 of blade ends 30, 60 are shown to have a sharpened surface suitable for interacting with one another in a scissor-like cutting relationship when the handles 26, 56 are moved from the open position to the closed position. One or both of the external edges 34, 64 of blade ends 30, 60 include a sharpened edge (shown for example as both external edges). According to the illustrated embodiment, external edge 34 is shown as a smooth or fine sharpened edge (e.g. knife edge, etc.) and external edge 64 is shown to include a serrated edge. However, either one or both of the external edges may be provided with any suitable surface configuration or cutting profile to permit the tool to be used for cutting objects in a non-scissor-like manner (e.g. in a chopping, slicing or reciprocating manner such as a knife or a saw), without opening the handles.

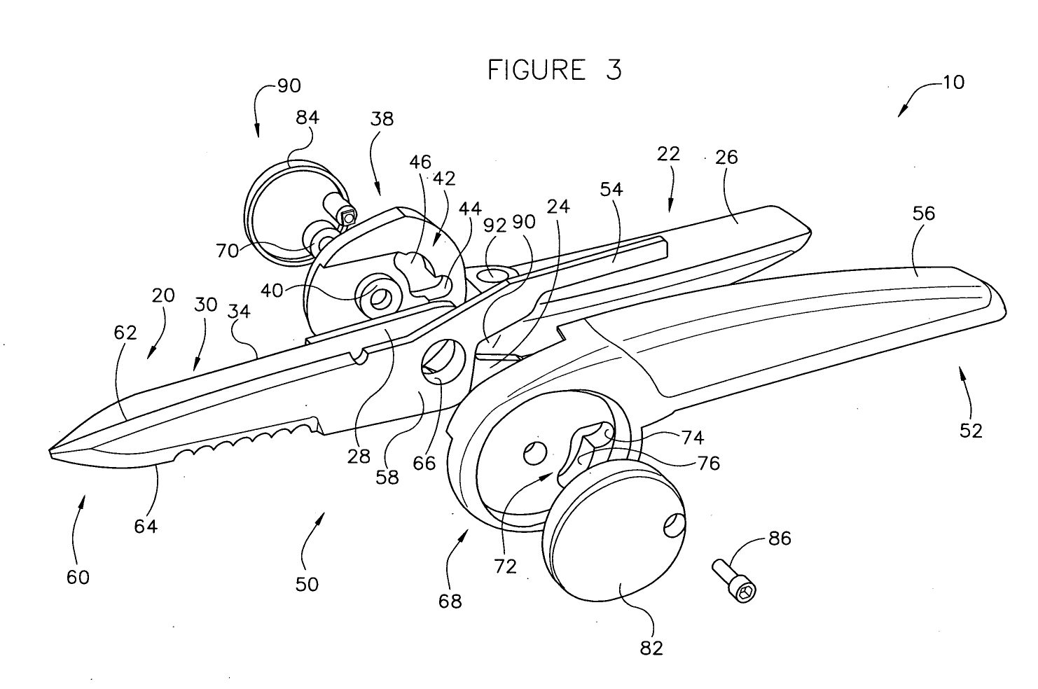

The handles 26, 56 are shown attached to the tangs 24, 54 and cooperate with the midportions 28, 58 to provide a pivot connection and to receive a lock device 80. Referring more particularly to FIG. 3, handles 26, 56 include a hub region 38, 68 with a hollow boss or post 40 that is sized to fit within apertures 66 for aligning the elongated members and the handles about the pivot point. A pivot pin 70 is provided in the form of a post or bushing for pivotally connecting the elongated members together (e.g. by a fastener, snap-connect, or the like). Each hub region 38, 68 is shown to include a slot 42, 72 having a first generally linear portion 44, 74 that align (e.g. overlap, coincide, etc.) with one another when the handles are in the closed position, and a second generally arcuate portion 46, 76 that align (e.g. overlap, coincide, etc.) with one another when the handles are in the open position. The lock device 80 includes two outer faces 82, 84 interconnected by a pin 86 that extends through the slots 42, 72. Each outer face 82, 84 of lock device 80 is slidably received in an elongated well or recess in its respective handle, so that handles 26, 56 may be locked when the lock device 80 is moved to position the pin 86 within the linear portions 44, 74 of the slots 42, 72, and the handles 26, 56 may be released when the lock device 80 is moved to position the pin 86 within the arcuate portions 46, 76 of the slots 42, 72.

A biasing device (such as a spring, and shown for example as a torsion spring 90) may be provided about the pivot point to urge the handles toward the open position to enhance the ease of use by a consumer. According to other embodiments, other types of springs (e.g. coil, leaf, etc.) may be used and provided at any suitable location to bias the handles to a desired position. In addition, contact pads 92 (e.g. bumpers, cushions, etc.) may be provided to cushion the impact when the handles are forced to a closed position (e.g. after severing an object in a scissor-like manner, etc.).

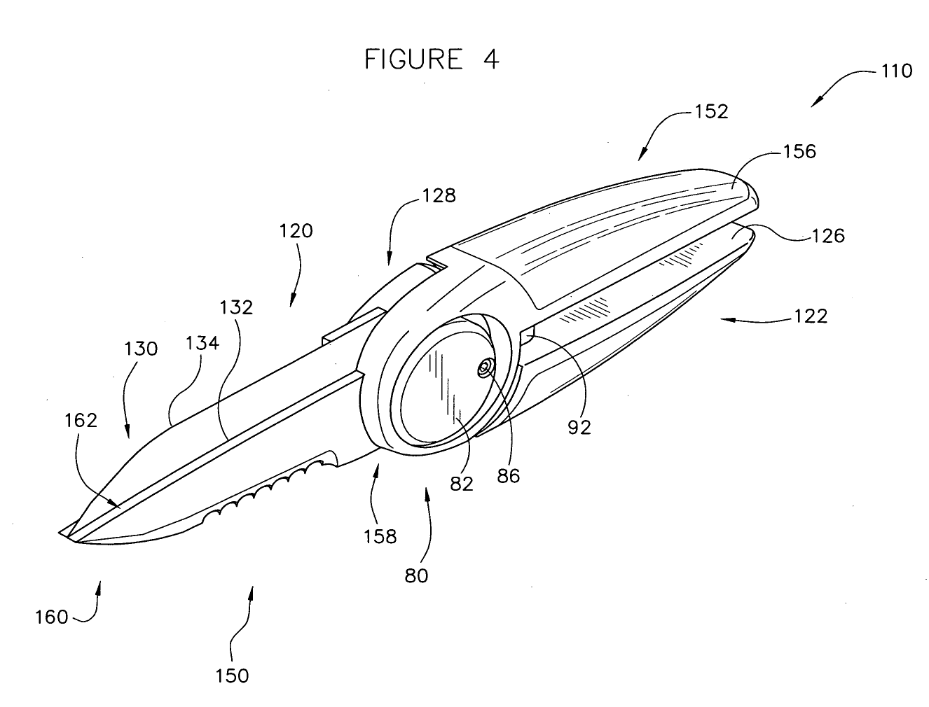

Referring to FIG. 4, a multi-function hand-operated cutting tool is shown according to another embodiment. Tool 110 is similar to tool 10 as previously described, however one elongated member 160 is provided with a jaw portion having a generally flat (e.g. planar, etc.) internal surface (shown for example as an “anvil” 162) arranged to abut or contact (e.g. “press-against”, etc.) the sharpened internal edge 132 of the other elongated member 120 when the handles 126, 156 are moved to the closed position to sever an object between the blade and the anvil. According to an alternative embodiment, the anvil and the sharpened internal edge of the blade may be curved and having generally matching profiles to promote contact along the interface between the blade and the anvil.

Referring further to FIG. 4, jaw 160 includes an external surface 164 (shown as a lower surface) having a sharpened edge, which may be a smooth cutting surface or a serrated cutting surface. According to an alternative embodiment, a single external sharpened edge may be provided (i.e. on either the external surface of the jaw or the external surface of the blade).

According to any exemplary embodiment, the hand-operated, multi-function cutting tool provides a tool having elongated members with both internally directed blade(s) or jaws for cutting objects placed between the blades or jaws (e.g. in a scissor/shearing manner or a compression/crushing manner), and externally directed blade(s) for externally cutting objects in a chopping, sawing, or knife-like manner. The handles may be integrally formed with the blades or may be separately formed and attached. The tool may be provided with, or without, a lock device (for maintaining the handles in a closed position) and/or a spring-assist (for biasing the blades/jaws and handles to an open position). The blade(s) may be formed from any material suitable for the application, such as steel. The handles may be made from a material such as (among others) glass-filled nylon, die-cast zinc, or plastic, in a molding or other suitable process.

It is also important to note that the construction and arrangement of the elements of the hand-operated, multi-function cutting tool as shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present invention. Other substitutions, modifications, changes and omissions may be made in the design, operating conditions and arrangement of the preferred and other exemplary embodiments without departing from the spirit of the present invention.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present invention as expressed in the appended claims.

What is claimed is:

1. A hand-operated multi-function cutting tool, comprising:
a first elongated member having a handle portion, a midportion, and a blade portion, the blade portion having a first cutting edge along a top of the blade portion and a second cutting edge along a bottom of the blade portion;
a second elongated member having a handle portion, a midportion, and a blade portion, the blade portion having a first cutting edge along a top of the blade portion and a second cutting edge along a bottom of the blade portion; and
a pivot which unites the midportions for scissor movement of the handle portions and the blade portions about the pivot.

2. The tool of claim 1 wherein the second cutting edge along the bottom of the blade portion of the first elongated member and the first cutting edge along the top of the blade portion of the second elongated member cooperate in a shearing relationship when the blade portions are moved from an open position to a closed position.

3. The tool of claim 1 wherein the first cutting edge along the top of the blade portion of the first elongated member comprises a knife edge, so that the tool can be used as a knife when the handle portions and the blade portions are in at least one of the open position and the closed position.

4. The tool of claim 1 wherein the second cutting edge along the bottom of the blade portion of the second elongated member comprises a serrated edge, so that the tool can be used as a saw when the handle portions and the blade portions are in the closed position.

5. The tool of claim 4 wherein the serrated edge comprises cutting teeth.

6. The tool of claim 1 further comprising a latch for holding the handle portions and the blade portions in a closed position.

7. The tool of claim 6 wherein the midportions further comprise slots that are aligned with one another when the handle portions and the blade portions are in the closed positions and the latch comprises a slide member that is slidable within the aligned slots between an unlocked position and a locked position.

8. The tool of claim 1 wherein the first cutting edge extending along the top of the blade portion of the first elongated member and the first cutting edge extending along the top of the blade portion of the second cutting member combine to form a double bevel cutting edge when the blade portions are in a closed position.

9. A hand-operated multi-function cutting tool, comprising:
first and second opposed elongated members, each member comprising a blade segment at a front end portion thereof, a handle segment at a rear end portion thereof, and a midportion where the members cross over each other;
each blade segment having an internal cutting edge;
at least one of the blades having an external cutting edge;
a pivot joint uniting the midportions for scissor movement of the handle segments and blade segments about the pivot joint between an open position and a closed position;
so that the internal cutting edges are configured to cut an object in a shearing manner and the external cutting edge is configured to cut an object in a non-shearing manner.

10. The tool of claim 9 wherein each blade segment comprises an external cutting edge.

11. The tool of claim 9 wherein one blade portion further comprises an internal recess configured to capture an object to be cut by the internal cutting edge of the other blade portion.

12. The tool of claim 10 further comprising a locking device movable between an unlocked position to permit scissor movement of the blade segments for cutting an object with the internal cutting edges, and a locked position to maintain the blade segments in a closed position to facilitate cutting of an object with at least one of the external cutting edges.

13. The tool of claim 12 wherein the locking device comprises a slidable lock that extends through a slot formed in the midportion of each elongated member.

14. The tool of claim 9 wherein the external cutting edge comprises a serrated cutting surface.

15. The tool of claim 9 wherein the external cutting edge comprises saw teeth.

16. The tool of claim 9 wherein the external cutting edge comprises a smooth knife edge.

17. The tool of claim 10 wherein at least one of the external cutting edges is operable to cut an object when the blade segments are in the open position and the closed position.

18. A hand-operated multi-function cutting tool, comprising:
first and second opposed elongated members, each member comprising a jaw at a front end portion thereof, a handle segment at a rear end portion thereof, and a midportion where the members cross over each other;
a pivot joint uniting the midportions for scissor movement of the handle segments and jaws about the pivot between an open position and a closed position;
one jaw having an internal anvil surface;
the other jaw having an internal cutting surface that engages the anvil surface when the handle segments are in the closed position; and
at least one of the jaws having an external cutting surface.

19. The tool of claim 18 wherein both jaws comprise an external cutting surface.

20. The tool of claim 19 wherein at least one of the external cutting surfaces comprises a serrated edge.
